(19) United States
(12) Patent Application Publication
(10) Pub. No.: US 2013/0332346 A1
(43) Pub. Date: Dec. 12, 2013

(54) SELF-SERVICE TERMINAL, SELF-SERVICE SYSTEM AND TRANSACTION SERVICE METHOD

(71) Applicant: Huawei Technologies Co., Ltd., Shenzhen (CN)

(72) Inventors: Zongbo Wang, Nanjing (CN); Yegang Su, Hangzhou (CN); Liangbing Lu, Hangzhou (CN)

(73) Assignee: Huawei Technologies Co., Ltd., Shenzhen (CN)

(21) Appl. No.: 13/962,799

(22) Filed: Aug. 8, 2013

Related U.S. Application Data
(63) Continuation of application No. PCT/CN2012/078928, filed on Jul. 20, 2012.

(30) Foreign Application Priority Data
Dec. 9, 2011 (CN) 201110409644.2

(51) Int. Cl. G06Q 20/18

(52) U.S. Cl. CPC G06Q 20/18
USPC 705/39

(57) ABSTRACT

Embodiments of the present invention disclose a self-service terminal, a self-service system and a transaction service method, to transact a financial transaction service for a user in a manner of interaction with a customer service personnel. The self-service terminal includes: a transaction service unit configured to provide a transaction service corresponding to a transaction service request to a user, according to the transaction service request of the user; and a transaction assistance unit configured to send a transaction assistance request to a customer service terminal according to the transaction service request and receive a transaction assistance response of the customer service terminal to the transaction assistance request, where the transaction assistance response includes auxiliary audio-video information used to assist in completing the transaction service provided by the transaction service unit.

### CROSS-REFERENCE TO RELATED APPLICATIONS

This application is a continuation of International Application No. PCT/CN2012/078928, filed on Jul. 20, 2012, which claims priority to Chinese Patent Application No. 201110409644.2, filed on Dec. 9, 2011, both of which are hereby incorporated by reference in their entireties.

### TECHNICAL FIELD

Embodiments of the present invention relate to the field of financial devices, and in particular, to a self-service terminal, a self-service system and a transaction service method.

### BACKGROUND

Current self-service terminals mostly adopt a pure physical hardware interaction technology of the last generation. Screens mostly support simple touch and click operations only. Under the constraint of special requirements of financial services, interaction manners are limited. On a conventional self-service terminal, only some simple cash and query services can be transacted. Most of financial services related to identity authentication cannot be transacted on a conventional financial terminal.

In the prior art, a self-service terminal where an audio-video customer service personnel is introduced appears, and when a user has a question, the user may turn to the audio-video customer service personnel for help.

However, in the prior art, the audio-video customer service personnel can only provide the user with an answer to a puzzle, and the user further needs to complete the specific service operation process in person. Because of the complexity of financial services, it may be difficult for the user to learn the operation process through simple communication, and therefore, it is difficult for the existing self-service terminal to assist the user in transacting a service whose operation process is comparatively complex.

### SUMMARY

Embodiments of the present invention provide a self-service terminal, a self-service system and a transaction service method, to transact a self-service transaction service for a user in a manner of interaction with customer service personnel.

A self-service terminal provided in the present invention includes: a transaction service unit, configured to, provide a transaction service corresponding to a transaction service request to a user according to the transaction service request of the user; and a transaction assistance unit, configured to, send a transaction assistance request to a customer service terminal according to the transaction service request, and receive a transaction assistance response from the customer service terminal which responds to the transaction assistance request, in which the transaction assistance response includes auxiliary audio-video information used to assist in completing the transaction service provided by the transaction service unit.

Alternatively, the auxiliary audio-video information includes: audio-video communication information and remote service operation information of a customer service personnel;

the transaction assistance unit includes: an audio-video assistance module and an operation assistance module;

the audio-video assistance module is configured to, establish audio-video communication between the self-service terminal and the customer service terminal according to the transaction assistance request, and transmit the audio-video communication information of the self-service terminal and the customer service terminal, to assist in completing the transaction service provided by the transaction service unit; and

the operation assistance module is configured to, display the remote service operation information of the customer service personnel at the customer service terminal according to the transaction assistance request, to assist in completing the transaction service provided by the transaction service unit.

Alternatively, the transaction assistance unit further includes: an identity recognition module, and a subscription module;

the identity recognition module is configured to receive an identity recognition request sent by the customer service terminal according to content of the transaction service, acquire identity authentication information of the user according to the identity recognition request, and return the identity authentication information to the customer service terminal;

the subscription module is configured to receive a document subscription request sent by the customer service terminal according to the content of the transaction service, provide a document subscription window of subscription information to the user according to the document subscription request, and return the acquired subscription information of the user to the customer service terminal;

correspondingly, the audio-video assistance module is further configured to, when the customer service terminal sends the identity recognition request and the document subscription request according to the content of the transaction service, transmit real-time audio-video communication information between the user of the self-service terminal and the customer service personnel of the customer service terminal; and

the operation assistance module is further configured to, when the customer service terminal sends the identity recognition request and the document subscription request according to the content of the transaction service, display operation guidance information of the customer service personnel at the customer service terminal, so that the user of the customer service terminal is capable of completing the transaction service according to the real-time audio-video communication information and the operation guidance information.

Alternatively, the transaction service unit includes: a display module, an information input module, an information extraction module, and a transaction module;

the information input module is configured to provide an information input interface for the user to input authorization information by which a pre-authorized transaction card performs transaction on the self-service terminal, and display the authorization information input by the user on the display module;

the information extraction module is configured to, after the user authorizes the pre-authorized transaction card to perform transaction on the self-service terminal, extract account information from an account in which the account information and the pre-authorized transaction card are associated, and display the account information on the display module; and

the transaction module is configured to, provide a transaction service relevant to the account corresponding to the account information according to the transaction service request, and send the transaction service request to the transaction assistance unit.

A transaction service method based on a self-service terminal provided in the present invention includes:

receiving, by a self-service terminal, a transaction instruction of a user, and providing a corresponding transaction service according to the transaction instruction of the user; and acquiring, by the self-service terminal, audio and video of service operation corresponding to the transaction instruction according to the transaction instruction to assist in completing the transaction service, in which the audio and video of service operation is audio and video of customer service personnel performing a service operation at a customer service terminal.

The transaction instruction includes: an audio-video assistance instruction, and an operation assistance instruction; and

the acquiring, by the self-service terminal, audio and video of service operation corresponding to the transaction instruction according to the transaction instruction to assist in completing the transaction service includes:

sending, by the self-service terminal, an audio-video session request to the customer service terminal according to the audio-video assistance instruction, and receiving a response from the customer service terminal which responds to the audio-video session request, to establish an audio-video session; and/or, sending, by the self-service terminal, a service operation assistance request to the customer service terminal according to the operation assistance instruction, and receiving a response from the customer service terminal which responds to the audio-video session request, to acquire audio-video of the customer service personnel performing a service operation at the customer service terminal.

Alternatively, the method further includes:

receiving, by the self-service terminal, an identity authentication instruction that is sent by the customer service terminal according to content of the transaction service, and displaying an identity authentication interface to the user according to the identity authentication instruction; and

receiving, by the self-service terminal, a subscription information instruction that is sent by the customer service terminal according to the content of the transaction service, and displaying a subscription information interface to the user according to the subscription information instruction.

A self-service system provided in the present invention includes: a customer service terminal and a self-service terminal, in which

the self-service terminal includes a transaction service unit and a transaction assistance unit;

the transaction service unit is configured to, provide a transaction service corresponding to the transaction service request to the user according to a transaction service request of a user; and the transaction assistance unit is configured to, send a transaction assistance request to the customer service terminal according to the transaction service request, and receive a transaction assistance response from the customer service terminal which responds to the transaction assistance request, in which the transaction assistance response includes auxiliary audio-video information used to assist in completing the transaction service provided by the transaction service unit; and

the customer service terminal is configured to receive the transaction assistance request that is sent by the self-service terminal according to the transaction service request, and send the transaction assistance response corresponding to the transaction assistance request to the self-service terminal.

Alternatively, the transaction assistance unit includes: an audio-video assistance module and an operation assistance module;

the auxiliary audio-video information includes: audio-video communication information and remote service operation information of a customer service personnel;

the audio-video assistance module is configured to, establish audio-video communication between the self-service terminal and the customer service terminal according to the assistance request, and transmit the audio-video communication information of the self-service terminal and the customer service terminal, to assist in completing the transaction service provided by the transaction service unit; and

the operation assistance module is configured to, display the remote service operation information of the customer service personnel according to the assistance request, to assist in completing the transaction service provided by the transaction service unit.

Alternatively, the transaction assistance unit further includes: an identity recognition module, and a subscription module;

the identity recognition module is configured to receive an identity recognition request that is sent by the customer service terminal according to content of the transaction service, acquire identity authentication information of the user according to the identity recognition request, and return the identity authentication information to the customer service terminal;

the subscription module is configured to receive a document subscription request that is sent by the customer service terminal according to the content of the transaction service, provide a document subscription window of subscription information to the user according to the document subscription request, and return the acquired subscription information of the user to the customer service terminal.

Alternatively, the transaction service unit includes: a display module, an information input module, an information extraction module, and a transaction module;

the information input module is configured to provide an information input interface to the user, to receive the transaction service request of the user, and display authorization information input by the user on the display module;

the information extraction module is configured to, after the user authorizes the pre-authorized transaction card to perform transaction on the self-service terminal, extract account information from an account in which the account information and the pre-authorized transaction card are associated, and display the account information on the display module; and

the transaction module is configured to, according to the transaction service request, provide the transaction service relevant to the account corresponding to the account information, and send the transaction service request to the transaction assistance unit.

A transaction service method based on a self-service terminal provided in the present invention includes: receiving, by a self-service system, a transaction instruction of a user, and providing a corresponding transaction service according to the transaction instruction of the user; and providing, by the self-service system, audio and video of service operation corresponding to the transaction instruction according to the transaction instruction, to assist in completing the transaction service, in which the audio and video of service operation is audio and video of a customer service personnel performing a service operation at a remote operation terminal.

Alternatively, the transaction instruction includes: an audio-video assistance instruction, and an operation assistance instruction; and

the providing, by the self-service system, audio and video of service operation corresponding to the transaction instruction according to the transaction instruction, to assist in completing the transaction service includes:

sending, by the self-service system, an audio-video session request to the customer service terminal according to the audio-video assistance instruction, and receiving a response from a customer service terminal which responds to the audio-video session request to establish an audio-video session; and/or, sending, by the self-service system, a service operation assistance request to the customer service terminal according to the operation assistance instruction, and receiving a response from the customer service terminal which responds to the operation assistance request, to acquire audio-video of the customer service personnel performing a service operation at the customer service terminal.

It can be seen from the foregoing technical solutions that, the embodiments of the present invention have the following advantages.

In the embodiments of the present invention, the self-service terminal includes the transaction assistance unit, and the user may call the remote customer service terminal through the transaction service unit, so that the customer service personnel may reveal a relevant service operation to the user through the customer service terminal, to assist the user in completing the transaction service provided by the transaction service unit. Therefore, when performing a transaction service, the user can intuitively and clearly understand the specific service process.

### BRIEF DESCRIPTION OF THE DRAWINGS

FIG. 1 is a schematic structural diagram of a self-service terminal in the present invention;

FIG. 2 is another schematic structural diagram of a self-service terminal in the present invention;

FIG. 3 is a schematic structural diagram of a self-service system in the present invention;

FIG. 4 is a schematic flowchart of a transaction service method based on a self-service terminal in the present invention; and

FIG. 5 is another schematic flowchart of a transaction service method based on a self-service terminal in the present invention.

### DETAILED DESCRIPTION

Embodiments of the present invention provide a self-service terminal, a self-service system and a transaction service method, to transact a financial transaction service for a user in a manner of interaction with customer service personnel.

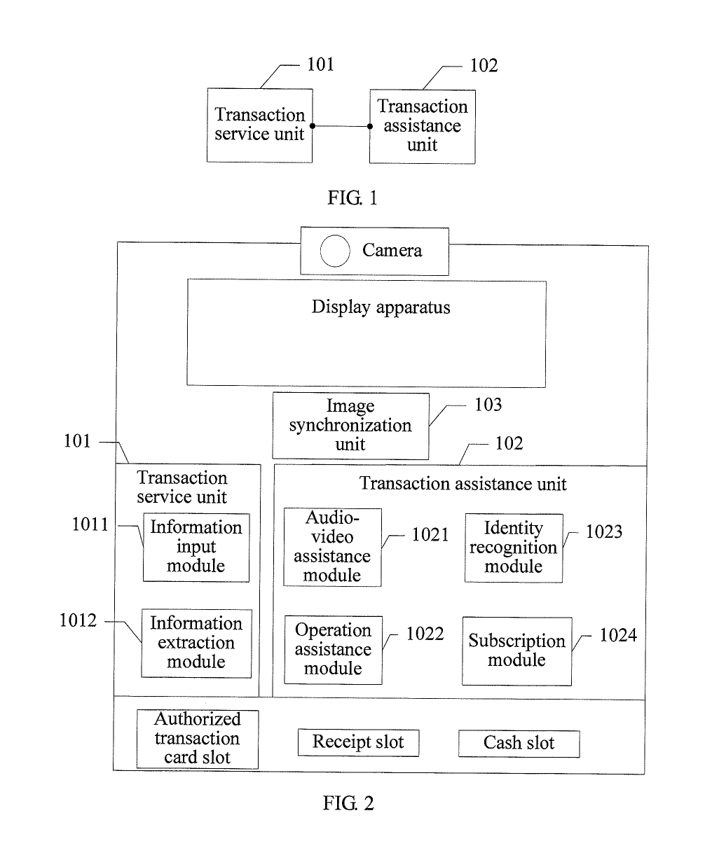

Referring to FIG. 1, an embodiment of a self-service terminal in an embodiment of the present invention includes:

a transaction service unit 101 and a transaction assistance unit 102.

The transaction service unit 101 is configured to provide a transaction service corresponding to a transaction service request to a user according to the transaction service request of the user. Specifically, the transaction service unit 101 may display a transaction service, which can be provided by the transaction service unit 101, to the user through a display module. After the user selects a corresponding transaction service (specifically, clicks a corresponding transaction service item), the transaction service unit 101 acquires a transaction service request corresponding to the transaction service, and executes the corresponding transaction service.

The transaction assistance unit is configured to, send a transaction assistance request to a customer service terminal according to the transaction service request, and receive a transaction assistance response from the customer service terminal which responds to the transaction assistance request, in which the transaction assistance response includes auxiliary audio-video information used to assist in completing the transaction service provided by the transaction service unit. Specifically, in an practical application, if the transaction service request acquired by the transaction service unit 101 is that the customer service terminal is requested to provide a service, the transaction service unit 101 calls the customer service terminal, and after the customer service terminal responds, the transaction assistance unit 102 displays a service operation of the customer service personnel on the customer service terminal, so as to assist in completing the transaction service provided by the transaction service unit 101.

The specific operation procedure of each unit in the self-service terminal according to the embodiment of the present invention is as follows:

The user calls the customer service terminal through the transaction service unit 101, and requests service assistance; the customer service terminal establishes a communication connection with the self-service terminal of the present invention.

When the user requires the customer service personnel to perform service operation assistance, the transaction assistance unit 102 displays the operation interface of the customer service personnel on the customer service terminal, and the customer service personnel demonstrates the service on the customer service terminal according to the request of the user, or directly assists the user in transacting the service. The entire procedure of the service demonstration or service transaction performed by the customer service personnel on the customer service terminal is synchronously displayed in the transaction assistance unit 102, and the user may intuitively understand the specific operation process, thereby improving user experience.

If the transaction service is used to request the service demonstration, after the user sees the demonstration operation of the customer service personnel in the transaction assistance unit 102, the user may transact a service through the transaction service unit 101 in person, and the specific information of transacting a service by the user through the transaction service unit 101 may be displayed on the display module of the transaction service unit 101. Alternatively, in practical technology implementation, the transaction assistance unit 102 may include an independent display module, while the display module of the transaction service unit 101 and the display module of the transaction assistance unit 102 may be the same display apparatus, or may be two display apparatuses, and the specific implementation manner may be determined according to the physical architecture layout of the self-service terminal, and is not limited herein.

If the transaction service is used to request the service transact assistance, the user may further perform an audio-video session with the customer service personnel through the transaction assistance unit 102, and then provides corresponding identity authentication information to the customer service personnel through the transaction assistance unit 102 according to an indication of the customer service personnel, so that the customer service personnel assists in transacting the service. The specific operation process is described in subsequent embodiments of the present application.

In the embodiment of the present invention, the self-service terminal includes the transaction assistance unit, and the user may call a remote customer service terminal through the transaction service unit, so that the customer service personnel may reveal a relevant service operation to the user through the customer service terminal, to assist the user in completing the transaction service provided by the transaction service unit. Therefore, when performing a transaction service, the user can intuitively and clearly understand the specific service process.

Referring to FIG. 2, another embodiment of a self-service terminal in an embodiment of the present invention includes:

a transaction assistance unit 102 in the embodiment of the present invention may include: an audio-video assistance module 1021, an operation assistance module 1022, an identity recognition module 1023, and a subscription module 1024; a transaction service unit 101 includes: a display module, an information input module 1011, an information extraction module 1012, and a transaction module.

The transaction assistance unit 102 is configured to, according to a transaction service request, send a transaction assistance request to a customer service terminal, and receive a transaction assistance response from the customer service terminal which responds to the transaction assistance request, in which the transaction assistance response includes auxiliary audio-video information used to assist in completing a transaction service provided by the transaction service unit. Specifically, the auxiliary audio-video information includes: audio-video communication information and remote service operation information of a customer service personnel;

the audio-video assistance module 1021 is configured to, establish audio-video communication between the self-service terminal and the customer service terminal according to the transaction assistance request, and transmit the audio-video communication information of the self-service terminal and the customer service terminal, to assist in completing the transaction service provided by the transaction service unit.

The operation assistance module 1022 is configured to display the remote service operation information of the customer service personnel according to the transaction assistance request and assist in completing the transaction service provided by the transaction service unit.

The identity recognition module 1023 is configured to receive an identity recognition request that is sent by the customer service terminal according to content of the transaction service, acquire identity authentication information of the user according to the identity recognition request, and return the identity authentication information to the customer service terminal. Specifically, the identity authentication information may specifically be fingerprint information, palm print information or pupil information of the user.

The subscription module 1024 is configured to receive a document subscription request that is sent by the customer service terminal according to the content of the transaction service, provide a document subscription window of subscription information to the user according to the document subscription request, and return the acquired subscription information of the user to the customer service terminal. When the user is required to provide subscription information, the customer service terminal sends a document subscription picture to the transaction assistance unit 102, and the document subscription picture is displayed on the document subscription window.

Correspondingly, the audio-video assistance module is configured to, when the customer service terminal sends the identity recognition request and the document subscription request according to the content of the transaction service, transmit real-time audio-video communication information between the user of the self-service terminal and the customer service personnel of the customer service terminal; and the operation assistance module is further configured to, when the customer service terminal sends the identity recognition request and the document subscription request according to the content of the transaction service, display operation guidance information of the customer service personnel at the customer service terminal, so that the user of the customer service terminal is capable of completing the transaction service according to the real-time audio-video communication information and the operation guidance information.

The information input module 1011 is configured to provide an information input interface for the user to input authorization information by which a pre-authorized transaction card performs transaction on the self-service terminal, and display the authorization information input by the user on the display module. Specifically, the input interface may be a physical keyboard input interface, and may also be a touch screen display interface, where the touch screen display interface may further be integrated on the display apparatus of the self-service terminal.

The information extraction module 1012 is configured to, after the user inserts the pre-authorized transaction card and confirms information of the pre-authorized transaction card, extract account information from an account in which the account information and the pre-authorized transaction card are associated, and display the account information on the display module. Specifically, the account information may be information in the pre-authorized transaction card, and may also be data information corresponding to the pre-authorized transaction card of the user in a bank system.

The transaction module is configured to provide a transaction service relevant to the account corresponding to the account information according to the transaction service request, and send the transaction service request to the transaction assistance unit 102.

The self-service terminal in the embodiment of the present invention may further include: an image synchronization unit 103, a pre-authorized transaction card slot, a receipt slot and a cash slot.

The image synchronization unit is configured to, when picture transmission needs to be performed between the display module, and the operation assistance module 1022 or the subscription module 1024, control a picture display transmission time sequence, so that image synchronization is implemented for the picture transmission between the display module, and the operation assistance module or the subscription module.

The specific interaction procedure of each unit in the self-service terminal of the embodiment of the present invention is as follows:

The user calls the customer service terminal through the transaction service unit 101, to request service assistance; the customer service terminal establishes a communication connection with the self-service terminal of the present invention.

Alternatively, after the customer service terminal establishes the communication connection with the self-service terminal of the present invention, the user may perform audio-video communication with the customer service personnel through the audio-video assistance module 1021 of the transaction assistance unit 102 (in this case, the auxiliary audio-video information provided by the customer service terminal is the audio-video communication information of the customer service personnel), that is, the user may perform “face to face” service communication with the customer service personnel through the audio-video assistance module 1021, so that a service transaction process is faster and more convenient.

When the user requests the customer service personnel to perform service operation assistance, the operation assistance module 1022 of the transaction assistance unit 102 displays the operation interface of the customer service personnel on the customer service terminal (in this case, the auxiliary audio-video information provided by the customer service terminal is the remote service operation information of the customer service personnel), and according to the request of the user, the customer service personnel performs service demonstration on the customer service terminal, or directly assists the user in transacting the service. The entire procedure of the service demonstration or service transaction performed by the customer service personnel on the customer service terminal is synchronously displayed in the operation assistance module 1022, and the user may intuitively understand the specific operation process, thereby improving user experience.

If the transaction service is used to request the service demonstration, after the user sees the demonstration operation of the customer service personnel in the operation assistance module 1022, the user may perform a service operation through the transaction service unit 101 in person, for example, the user inserts the pre-authorized transaction card into the pre-authorized transaction card slot, and the information extraction module 1012 of the transaction service unit 101 extracts the account information of the pre-authorized transaction card, and displays the account information on a corresponding display module. The user may input operation information or user information through the information input module 1011 of the transaction service unit 101. Specifically, the information input module 1011 may be a physical keyboard input interface, and may also be a touch screen display interface, where the touch screen display interface may further be integrated on the display module of the self-service terminal. When the operation procedure is related to cash transaction, the user may deposit or withdraw cash from the cash slot; after the relevant operation is completed, the user may acquire a corresponding receipt of this service from the receipt slot.

If the transaction service is used to request the service transaction assistance, then in an audio-video session with the customer service personnel, the user may provide corresponding identity authentication information in the identity recognition module 1023 according to the indication of the customer service personnel. Specifically, if identity authentication needs to be performed, the user may input corresponding fingerprint information, palm print information or pupil information to the identity recognition module 1023. If file subscription needs to be performed, the customer service terminal sends a document subscription picture to the transaction assistance unit 102, and the document subscription picture is displayed in the subscription module 1024; after seeing the document subscription picture, the user may complete relevant file subscription on the subscription module 1024.

Alternatively, when picture transmission needs to be performed between the display module, and the operation assistance module or the subscription module, the display for picture transmission is provided with an image synchronization function, and details are as follows:

For example, when the customer service terminal needs to provide a document subscription picture to the self-service terminal, the customer service personnel first reveals the document subscription picture on the operation assistance module 1022, and after a remote customer service personnel clicks a sending operation, the display effect on the self-service terminal is as follows: the document subscription picture slides from the operation assistance module 1022 into the subscription module. Specifically, for example, the operation assistance module 1022 is above the subscription module 1024, and after the remote customer service personnel clicks a sending operation, the image synchronization unit 103 controls the document subscription picture to gradually disappear in the operation assistance module 1022 from bottom to top, while synchronously the part disappearing in the operation assistance module 1022 is also gradually displayed on the subscription module 1024, so that for the user, the document subscription picture seems to slide from the operation assistance module 1022 to the subscription module 1024 visually.

Also, for example, when the customer service terminal needs to provide a document picture of a relevant regulation to the self-service terminal, to be read by the user, after the customer service personnel clicks a sending operation, the image synchronization unit 103 controls the document picture to gradually slide from the operation assistance module 1022 to the display module.

Further, image synchronization may also be implemented between the display module or the operation assistance module 1022 and the receipt slot or cash slot. For example, after the user clicks a receipt output instruction on the self-service terminal, a relevant receipt is displayed in the display module, then the image synchronization unit 103 controls the receipt to gradually disappear in the display module from top to bottom, and the part disappearing in the display module is gradually output from the receipt slot. It should be noted that, herein a real receipt is output from the receipt slot, while a virtual receipt picture disappears in the display module, and in the present invention, the synchronization function of a virtual picture and a dynamic image of a corresponding entity needs to be implemented.

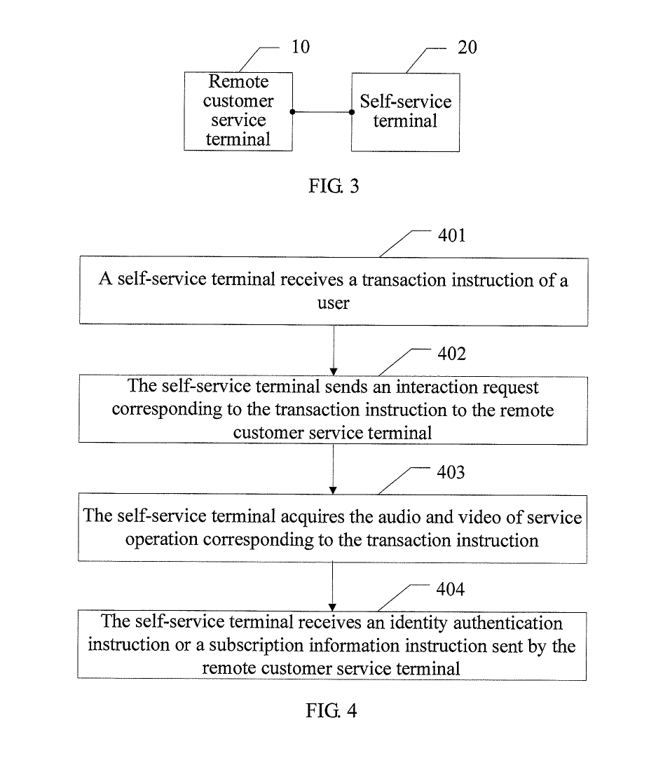

Referring to FIG. 3, an embodiment of a self-service financial system in an embodiment of the present invention includes:

a customer service terminal 10 and a self-service terminal 20.

The self-service terminal 20 includes a transaction service unit and a transaction assistance unit; the transaction service unit is configured to, according to a transaction service request of a user, provide a transaction service corresponding to the transaction service request to the user; and the transaction assistance unit is configured to, according to the transaction service request, send a transaction assistance request to the customer service terminal, and receive a transaction assistance response from the customer service terminal which responds to the transaction assistance request, in which the transaction assistance response includes auxiliary audio-video information used to assist in completing the transaction service provided by the transaction service unit; and

the customer service terminal 10 is configured to receive the transaction assistance request that is sent by the self-service terminal according to the transaction service request, and send the transaction assistance response corresponding to the transaction assistance request to the self-service terminal.

The transaction assistance unit in the embodiment of the present invention may include: an audio-video assistance module, an operation assistance module, an identity recognition module, and a subscription module; the transaction service unit includes: a display module, an information input module, an information extraction module, and a transaction module.

The transaction assistance unit is configured to, according to the transaction service request, send a transaction assistance request to a customer service terminal, and receive a transaction assistance response from the customer service terminal which responds to the transaction assistance request, in which the transaction assistance response includes auxiliary audio-video information used to assist in completing the transaction service provided by the transaction service unit. Specifically, the auxiliary audio-video information includes: audio-video communication information and remote service operation information of a customer service personnel.

The audio-video assistance module is configured to, according to the transaction assistance request, establish audio-video communication between the self-service terminal and the customer service terminal, and transmit the audio-video communication information of the self-service terminal and the customer service terminal, so as to assist in completing the transaction service provided by the transaction service unit.

The operation assistance module is configured to, according to the transaction assistance request, display the remote service operation information of the customer service personnel and assist in completing the transaction service provided by the transaction service unit.

The identity recognition module is configured to receive an identity recognition request that is sent by the customer service terminal according to content of the transaction service, acquire identity authentication information of the user according to the identity recognition request, and return the identity authentication information to the customer service terminal. Specifically, the identity authentication information may specifically be fingerprint information, palm print information or pupil information of the user.

The subscription module is configured to receive a document subscription request that is sent by the customer service terminal according to the content of the transaction service, provide a document subscription window of subscription information to the user according to the document subscription request, and return the acquired subscription information of the user to the customer service terminal. When the user is required to provide subscription information, the customer service terminal sends a document subscription picture to the transaction assistance unit, and the document subscription picture is displayed on the document subscription window.

Correspondingly, the audio-video assistance module is further configured to, when the customer service terminal sends the identity recognition request and the document subscription request according to the content of the transaction service, transmit real-time audio-video communication information between the user of the self-service terminal and the customer service personnel of the customer service terminal; and the operation assistance module is further configured to, when the customer service terminal sends the identity recognition request and the document subscription request according to the content of the transaction service, display operation guidance information of the customer service personnel at the customer service terminal, so that the user of the customer service terminal is capable of completing the transaction service according to the real-time audio-video communication information and the operation guidance information.

The information input module is configured to provide an information input interface to the user, so as to receive the transaction service request of the user, and display authorization information input by the user on the display module. Specifically, the input interface may be a physical keyboard input interface, and may also be a touch screen display interface, where the touch screen display interface may further be integrated on the display apparatus of the self-service terminal.

The information extraction module is configured to, after the user inserts a pre-authorized transaction card and confirms information of the pre-authorized transaction card, extract account information from an account in which the account information and the pre-authorized transaction card are associated and display the account information on the display module. Specifically, the account information may be information in the pre-authorized transaction card, and may also be data information corresponding to the pre-authorized transaction card of the user in a bank system.

The transaction module is configured to provide a transaction service relevant to the account corresponding to the account information according to the transaction service request and send the transaction service request to the transaction assistance unit.

The self-service terminal in the embodiment of the present invention may further include: an image synchronization unit, a pre-authorized transaction card slot, a receipt slot and a cash slot.

The image synchronization unit is configured to, when picture transmission needs to be performed between the display module and the operation assistance module or the subscription module, control a picture display transmission time sequence, so that image synchronization is implemented for the picture transmission between the display module and the operation assistance module or the subscription module.

The customer service terminal 10 is further configured to send a document subscription picture to the transaction assistance unit, so that the document subscription picture is displayed on the document subscription window.

Alternatively, when picture transmission needs to be performed between the display module and the operation assistance module or the subscription module, the display for picture transmission is provided with an image synchronization function, and details are as follows:

For example, when the customer service terminal needs to provide a document subscription picture to the self-service terminal, the customer service personnel first reveals the document subscription picture on the operation assistance module, and after a remote customer service personnel clicks a sending operation, the display effect on the self-service terminal 20 is as follows: the document subscription picture slides from the operation assistance module into the subscription module. Specifically, for example, the operation assistance module is above the subscription module, and after the remote customer service personnel clicks a sending operation, the image synchronization unit controls the document subscription picture to gradually disappear in the operation assistance module from bottom to top, while synchronously the part disappearing in the operation assistance module is also gradually displayed on the subscription module, so that for the user, the document subscription picture seems to slide from the operation assistance module to the subscription module visually.

The customer service terminal 10 is further configured to manipulate the pre-authorized transaction card slot and the receipt slot. For example, when the user requires the customer service personnel to assist in transacting the application for a pre-authorized transaction card, after the application of the user is completed, the customer service personnel may provide the pre-authorized transaction card applied successfully to the user through the customer service terminal 10. Specifically, the customer service personnel may click an output button of the pre-authorized transaction card in the customer service terminal 10, and the pre-authorized transaction card slot at the self-service terminal spits out a new pre-authorized transaction card applied successfully.

For ease of understanding, the self-service financial system in the foregoing embodiment is described in detail below in a specific application scenario, and details are as follows:

The user clicks an audio-video call button in the transaction service unit, and waits for the response of the customer service terminal; after the customer service personnel receives an interaction request at a remote customer service terminal, the customer service personnel selects to respond, and the customer service terminal establishes a communication connection with the self-service terminal.

After the communication connection is established, the picture of the customer service personnel is displayed in the display module, while the voice session between the customer service personnel and the user may be transmitted through the voice unit of the embodiment of the present invention. In the procedure of communication between the customer service personnel and the user, the user may express a service willingness to the customer service personnel, for example, to transact a financing service, and the customer service personnel may display a service document, which needs to be recommended, in the display module for the user through the operation assistance module, so the effect of face-to-face service understanding and service popularization between the user and the customer service personnel can be achieved through the self-service system of the present invention.

When the user expresses that the user needs to purchase a certain financing product, the customer service personnel prompts the user to insert the pre-authorized transaction card. The user inserts the pre-authorized transaction card into the pre-authorized transaction card slot, and the information extraction module extracts the account information of the pre-authorized transaction card, and displays the account information in the display module.

After the pre-authorized transaction card inserted by the user passes the authentication of a bank system, the transaction assistance unit may prompt the customer service terminal may continue to transact a financing product purchase service.

According to financial service transaction requirements, the customer service personnel requires the user to read and subscribe a financing purchase agreement. After the customer service terminal completes the corresponding financing product purchase operation, the customer service personnel sends the picture of the agreement document to the transaction assistance unit of the self-service terminal. Specifically, the picture of the agreement document slides from the display module to the subscription module of the transaction assistance unit, and after reading the agreement document, the user subscribes relevant information (such as, the name of the user) on the subscription module for confirmation. After the subscription is completed, the transaction assistance unit sends the subscribed agreement document back to the customer service terminal, to complete the submission of the document.

After the service is transacted successfully, financing data in a financing account is displayed on the display module of the self-service terminal. The customer service personnel may further inquire whether the user needs a relevant receipt, and after the user agrees, the receipt is output from the receipt slot. Alternatively, an image synchronization display function may also be adopted for the display procedure of receipt output, that is, the receipt slides from the display module to the receipt slot, and a paper receipt appears from the receipt slot synchronously.

The application scenario of the embodiment of the present invention is illustrated through some examples, and it can be understood that, in actual applications, more application scenarios may exist, which is not specifically limited herein.

Referring to FIG. 4, in an embodiment of the present invention, an embodiment of a transaction service method that is based on a self-service terminal and is corresponding to the foregoing self-service terminal includes:

401: A self-service terminal receives a transaction instruction of a user.

The self-service terminal receives the transaction instruction of the user and provides a corresponding transaction service according to the transaction instruction of the user.

In an practical application, the transaction instruction includes an audio-video assistance instruction and an operation assistance instruction; the audio-video assistance instruction is used to instruct the self-service terminal to send an audio-video session request to a customer service terminal; the operation assistance instruction is used to instruct the self-service terminal to send a service operation assistance request to the customer service terminal.

402: The self-service terminal sends an interaction request corresponding to the transaction instruction to the customer service terminal.

The self-service terminal sends the interaction request corresponding to the transaction instruction to the customer service terminal.

Alternatively, if the transaction instruction is the audio-video assistance instruction, the self-service terminal sends the audio-video session request to the customer service terminal according to the audio-video assistance instruction, and receives a response from a customer service terminal which responds to the audio-video session request, to establish an audio-video session.

Alternatively, if the transaction instruction is the operation assistance instruction, the self-service terminal sends a service operation assistance request to the customer service terminal according to the operation assistance instruction, and receives a response from a customer service terminal which responds to the operation assistance request, to acquire audio-video of customer service personnel performing a service operation at the customer service terminal.

The foregoing remote assistance is specifically as follows: the service operation of the customer service personnel on the customer service terminal is synchronously displayed on a local self-service terminal. Alternatively, in order to protect information security of the user and a bank party, content of the remote assistance may only be limited to display the content of a designated window on the customer service terminal to the user, the customer service personnel cannot operate the self-service terminal, and the user cannot operate the customer service terminal.

Further, the self-service terminal may further send both the audio-video session request and the service operation assistance request to the customer service terminal. During specific implementation, the audio-video assistance instruction and the operation assistance instruction may be integrated into the same button, that is, when the user clicks a certain button, the self-service terminal sends both the audio-video session request and the service operation assistance request to the customer service terminal, so that when the customer service terminal establishes remote assistance with a local self-service terminal, the user and the customer service personnel may further exchange service information through audio-video communication at the same time, to further improve the convenience and user experience of service processing.

403: The self-service terminal acquires the audio and video of service operation corresponding to the transaction instruction.

The self-service terminal acquires the audio and video of service operation corresponding to the transaction instruction according to the transaction instruction, to assist in completing the transaction service, in which the audio and video of service operation is audio and video of the customer service personnel performing a service operation at a remote operation terminal.

After the customer service terminal receives the service operation assistance request initiated by the user, the customer service personnel selects to respond, the customer service terminal establishes remote assistance with the self-service terminal, and then the self-service terminal may acquire the audio-video of the customer service personnel performing a service operation on the customer service terminal.

Alternatively, if the self-service terminal sends the audio-video session request to the customer service terminal at the same time, the customer service terminal establishes audio-video communication with the self-service terminal, the self-service terminal and the customer service terminal may acquire recorded audio-video of the peer end, and the user and the customer service personnel may perform interaction communication through the audio-video of the voice and picture.

404: The self-service terminal receives an identity authentication instruction or a subscription information instruction sent by the customer service terminal.

Alternatively, after the customer service terminal establishes remote assistance with the self-service terminal, if the transaction service is used to request assist in service transaction, the customer service personnel may require the user to provide identity authentication information in the procedure of transacting a service for the user. In this case, the customer service terminal sends the identity authentication instruction to the self-service terminal according to the content of the transaction service, so that the user provides the corresponding identity authentication information in the identity recognition module of the self-service terminal. Specifically, the user may input corresponding fingerprint, palm print or pupil information into the identity recognition module, and then the self-service terminal sends the fingerprint, palm print or pupil information to the customer service terminal.

Alternatively, after the customer service terminal establishes remote assistance with the self-service terminal, if the transaction service is used to request assist in service transaction, the customer service personnel may require the user to provide file subscription information in the procedure of transacting a service for the user, and the customer service terminal sends the subscription information instruction to the self-service terminal according to the content of the transaction service, so that the user subscribes relevant information (such as the name of the user) on the subscription module of the self-service terminal, and then the self-service terminal sends the relevant information subscribed by the user to the customer service terminal.

In the embodiment of the present invention, the self-service terminal may establish remote assistance with the customer service terminal through the transaction instruction initiated by the user, so that the service operation of the customer service personnel on the customer service terminal is synchronously displayed on the self-service terminal, the user may put forward his/her own service request through an audio-video session, and a remote customer service personnel may perform a service operation at the customer service terminal correspondingly, to assist the user in transacting a service, and reveal the operation procedure to the user synchronously at the same time, so that the entire service transaction procedure becomes transparent and distinct, thereby improving user experience.

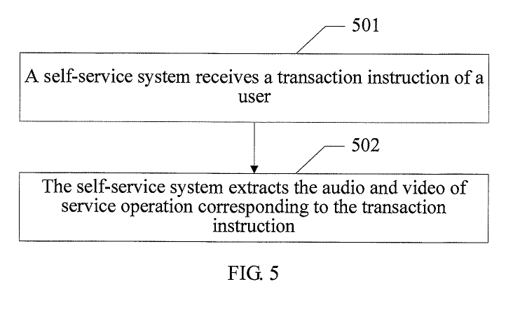

Referring to FIG. 5, in an embodiment of the present invention, an embodiment of a transaction service method that is based on a self-service terminal and is corresponding to the foregoing self-service system includes:

501: A self-service system receives a transaction instruction of a user.

The self-service system receives the transaction instruction of the user and provides a corresponding transaction service according to the transaction instruction of the user.

In a practical application, the transaction instruction includes an audio-video assistance instruction and an operation assistance instruction; the audio-video assistance instruction is used to instruct the self-service system to send an audio-video session request to a customer service terminal; the operation assistance instruction is used to instruct the self-service system to send a service operation assistance request to the customer service terminal.

502: The self-service system extracts the audio and video of service operation corresponding to the transaction instruction.

The self-service system extracts the audio and video of service operation corresponding to the transaction instruction according to the transaction instruction, and the audio and video of service operation is the audio and video of the customer service personnel performing a service operation at a remote operation terminal, so that the self-service system displays the service operation performed by the customer service personnel at the remote operation terminal to the user. Specifically, the transaction instruction may be the operation assistance instruction, the self-service system sends a service operation assistance request to the customer service terminal according to the operation assistance instruction, and receives a response from a customer service terminal which responds to the operation assistance request, to acquire audio-video of customer service personnel performing a service operation at the customer service terminal.

Alternatively, if the transaction instruction is the audio-video assistance instruction, the self-service system sends the audio-video session request to the customer service terminal according to the audio-video assistance instruction, and receives a response from the customer service terminal which responds to the audio-video session request, to establish an audio-video session.

In the embodiments provided in the present application, it should be understood that the disclosed apparatuses and methods may be implemented through other manners. For example, the described apparatus embodiments are merely exemplary. For example, the unit division is merely logical function division and can be other division in actual implementation. For example, multiple units or components can be combined or integrated into another system, or some features can be ignored or not performed. In addition, the displayed or discussed mutual couplings or direct couplings or communication connections are implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network elements. A part or all of the units may be selected according to the actual needs to achieve the objectives of the solutions of the embodiments.

In addition, functional units in each embodiment of the present invention may be integrated into a processing unit, or each of the units may exist alone physically, or two or more units are integrated into one unit. The integrated unit may be implemented in a form of hardware, or may be implemented in a form of a software functional unit.

When being implemented in the form of a software functional unit and sold or used as a separate product, the integrated unit may be stored in a computer-readable storage medium. Based on such understanding, the essence of the technical solutions of the present invention, or the part contributing to the prior art, or all or a part of the technical solutions may be implemented in a form of a software product. The computer software product is stored in a storage medium and includes several instructions for instructing a computer device (which may be a personal computer, a server, a network device, or the like) to execute all or a part of steps of the method described in each embodiment of the present invention. The storage medium includes: any medium that can store program code, such as a U-disk, a removable hard disk, a read-only memory (ROM, Read-Only Memory), a random access memory (RAM, Random Access Memory), a magnetic disk, or an optical disk.

The foregoing description is merely exemplary embodiments of the present invention, but the protection scope of the present invention is not limited thereto. Any variation or replacement made by persons skilled in the art within the technical scope disclosed by the present invention shall fall within the protection scope of the present invention. Therefore, the protection scope of the present invention shall be subject to the appended claims.

What is claimed is:

1. A self-service terminal, comprising:
a transaction service unit configured to provide a transaction service corresponding to a transaction service request to a user according to the transaction service request of the user; and
a transaction assistance unit configured to send a transaction assistance request to a customer service terminal according to the transaction service request and receive a transaction assistance response from the customer service terminal which responds to the transaction assistance request, wherein the transaction assistance response comprises auxiliary audio-video information used to assist in completing the transaction service provided by the transaction service unit.

2. The self-service terminal according to claim 1, wherein
the auxiliary audio-video information comprises: audio-video communication information and remote service operation information of a customer service personnel;
the transaction assistance unit comprises: an audio-video assistance module and an operation assistance module;
the audio-video assistance module is configured to establish audio-video communication between the self-service terminal and the customer service terminal according to the transaction assistance request and transmit the audio-video communication information of the self-service terminal and the customer service terminal, to assist in completing the transaction service provided by the transaction service unit; and
the operation assistance module is configured to display the remote service operation information of the customer service personnel at the customer service terminal according to the transaction assistance request and assist in completing the transaction service provided by the transaction service unit.

3. The self-service terminal according to claim 2, wherein
the transaction assistance unit further comprises: an identity recognition module and a subscription module;
the identity recognition module is configured to receive an identity recognition request that is sent by the customer service terminal according to content of the transaction service, acquire identity authentication information of the user according to the identity recognition request, and return the identity authentication information to the customer service terminal;
the subscription module is configured to receive a document subscription request that is sent by the customer service terminal according to the content of the transaction service, provide a document subscription window of subscription information to the user according to the document subscription request, and return the acquired subscription information of the user to the customer service terminal;
correspondingly, the audio-video assistance module is further configured to, when the customer service terminal sends the identity recognition request and the document subscription request according to the content of the transaction service, transmit real-time audio-video communication information between the user of the self-service terminal and the customer service personnel of the customer service terminal; and
the operation assistance module is further configured to, when the customer service terminal sends the identity recognition request and the document subscription request according to the content of the transaction service, display operation guidance information of the customer service personnel at the customer service terminal, so that the user of the customer service terminal is capable of completing the transaction service according to the real-time audio-video communication information and the operation guidance information.

4. The self-service terminal according to claim 3, wherein the transaction service unit comprises: a display module, an information input module, an information extraction module, and a transaction module;
the information input module is configured to provide an information input interface for the user to input authorization information by which a pre-authorized transaction card performs transaction on the self-service terminal and display the authorization information input by the user on the display module;
the information extraction module is configured to, after the user authorizes the pre-authorized transaction card to perform transaction on the self-service terminal, extract account information from an account in which the account information and the pre-authorized transaction card are associated and display the account information on the display module; and
the transaction module is configured to provide the transaction service relevant to the account corresponding to the account information according to the transaction service request and send the transaction service request to the transaction assistance unit.

5. A transaction service method based on a self-service terminal, the method comprising:
receiving, by a self-service terminal, a transaction instruction of a user and providing a corresponding transaction service according to the transaction instruction of the user; and
acquiring, by the self-service terminal, audio and video of service operation corresponding to the transaction instruction according to the transaction instruction to assist in completing the transaction service, wherein the audio and video of service operation is audio and video of customer service personnel performing a service operation at a customer service terminal.

6. The method according to claim 5, wherein the transaction instruction comprises: an audio-video assistance instruction and an operation assistance instruction; and
the acquiring, by the self-service terminal, audio and video of service operation corresponding to the transaction instruction according to the transaction instruction to assist in completing the transaction service comprises:
sending, by the self-service terminal, an audio-video session request to a customer service terminal according to the audio-video assistance instruction and receiving a response from the customer service terminal which responds to the audio-video session request, to establish an audio-video session;
and/or, sending, by the self-service terminal, a service operation assistance request to the customer service terminal according to the operation assistance instruction and receiving a response from the customer service terminal which responds to the service operation assistance request, to acquire audio-video of the customer service personnel performing a service operation at the customer service terminal.

7. The method according to claim 5, further comprising:
receiving, by the self-service terminal, an identity authentication instruction that is sent by a customer service terminal according to content of the transaction service and displaying an identity authentication interface to the user according to the identity authentication instruction; and
receiving, by the self-service terminal, a subscription information instruction that is sent by the customer service terminal according to the content of the transaction service and displaying a subscription information interface to the user according to the subscription information instruction.

8. A self-service system, comprising:
a customer service terminal and a self-service terminal, wherein
the self-service terminal comprises a transaction service unit and a transaction assistance unit;
the transaction service unit is configured to provide a transaction service corresponding to a transaction service request to a user according to the transaction service request of the user; and the transaction assistance unit is configured to send a transaction assistance request to the customer service terminal according to the transaction service request and receive a transaction assistance response from the customer service terminal which responds to the transaction assistance request, wherein the transaction assistance response comprises auxiliary audio-video information used to assist in completing the transaction service provided by the transaction service unit; and
the customer service terminal is configured to receive the transaction assistance request that is sent by the self-service terminal according to the transaction service request and send the transaction assistance response corresponding to the transaction assistance request to the self-service terminal.

9. The self-service system according to claim 8, wherein
the transaction assistance unit comprises: an audio-video assistance module and an operation assistance module;
the auxiliary audio-video information comprises: audio-video communication information and remote service operation information of a customer service personnel;
the audio-video assistance module is configured to establish audio-video communication between the self-service terminal and the customer service terminal according to the assistance request and transmit the audio-video communication information of the self-service terminal and the customer service terminal, to assist in completing the transaction service provided by the transaction service unit; and
the operation assistance module is configured to display the remote service operation information of the customer service personnel according to the assistance request to assist in completing the transaction service provided by the transaction service unit.

10. The self-service system according to claim 9, wherein
the transaction assistance unit further comprises: an identity recognition module, and a subscription module;
the identity recognition module is configured to receive an identity recognition request that is sent by the customer service terminal according to content of the transaction service, acquire identity authentication information of the user according to the identity recognition request, and return the identity authentication information to the customer service terminal; and
the subscription module is configured to receive a document subscription request that is sent by the customer service terminal according to the content of the transaction service, provide a document subscription window of subscription information to the user according to the document subscription request, and return the acquired subscription information of the user to the customer service terminal.

11. The self-service system according to claim 10, wherein the transaction service unit comprises: a display module, an information input module, an information extraction module, and a transaction module;
the information input module is configured to provide an information input interface to the user, receive the transaction service request of the user, and display authorization information input by the user on the display module;
the information extraction module is configured to, after the user authorizes a pre-authorized transaction card to perform transaction on the self-service terminal, extract account information from an account in which the account information and the pre-authorized transaction card are associated and display the account information on the display module; and
the transaction module is configured to, according to the transaction service request, provide the transaction service relevant to the account corresponding to the account information and send the transaction service request to the transaction assistance unit.

12. A method for assisting a self-service terminal in implementing a transaction service, the method comprising:
receiving, by a self-service system, a transaction instruction of a user and providing a corresponding transaction service according to the transaction instruction of the user; and
providing, by the self-service system, audio and video of service operation corresponding to the transaction instruction according to the transaction instruction, to assist in completing the transaction service, wherein the audio and video of service operation is audio and video of a customer service personnel performing a service operation at a remote operation terminal.

13. The method according to claim 12, wherein the transaction instruction comprises:
an audio-video assistance instruction and an operation assistance instruction; and
the providing, by the self-service system, audio and video of service operation corresponding to the transaction instruction according to the transaction instruction, to assist in completing the transaction service comprises:
sending, by the self-service system, an audio-video session request to a customer service terminal according to the audio-video assistance instruction and receiving a response from a customer service terminal which responds to the audio-video session request, to establish an audio-video session;
and/or, sending, by the self-service system, a service operation assistance request to the customer service terminal according to the operation assistance instruction and receiving a response from the customer service terminal which responds to the operation assistance request, to acquire audio-video of customer service personnel performing a service operation at the customer service terminal.
